(19) United States
(12) Patent Application Publication
(10) Pub. No.: US 2022/0027798 A1
(43) Pub. Date: Jan. 27, 2022

(54) AUTONOMOUS BEHAVIORS IN A MULTIAGENT ADVERSARIAL SCENE

(71) Applicant: SPARKCOGNITION, INC., AUSTIN, TX (US)

(72) Inventors: ELAD LIEBMAN, AUSTIN, TX (US); ALEXANDRU ARDEL, AUSTIN, TX (US); JACOB RIEDEL, AUSTIN, TX (US); EDGARS VITOLINS, AUSTIN, TX (US); SHASHANK BASSI, AUSTIN, TX (US)

(21) Appl. No.: 16/938,478

(22) Filed: Jul. 24, 2020

(51) Int. Cl. G06N 20/20; G06N 5/04

(52) U.S. Cl. CPC G06N 20/20; B64C 39/024; G06N 5/043

(57) ABSTRACT

Autonomous behaviors in a multiagent adversarial scene, including: assigning, by a scene manager, to each friendly agent of plurality of friendly agents, a role comprising an engagement to an adversarial agent of one or more adversarial agents; assigning, by the scene manager, to each friendly agent of the plurality of friendly agents, a policy; and wherein each friendly agent of the plurality of friendly agents is configured to determine, based on a tactical model corresponding to the assigned policy, one or more actions.

### BACKGROUND

### Field of the Invention

The field of the invention is machine learning, or, more specifically, methods, systems, and products for autonomous behaviors in a multiagent adversarial scene.

### Description of Related Art

Machine learning models may be used to determine autonomous behaviors for various scenarios. Existing implementations may require extensive training and complex performance in order to achieve a unified model for operation.

### SUMMARY

Autonomous behaviors in a multiagent adversarial scene may include: assigning, by a scene manager, to each friendly agent of a plurality of friendly agents, a role comprising an engagement to an adversarial agent of one or more adversarial agents; assigning, by the scene manager, to each friendly agent of the plurality of friendly agents, a policy; and wherein each friendly agent of the plurality of friendly agents is configured to determine, based on a tactical model corresponding to the assigned policy, one or more actions.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is an example view of an execution environment for autonomous behaviors in a multiagent adversarial scene.

FIG. 2 is a graphical representation of an example simulated multiagent adversarial scene.

FIG. 3 is a graphical representation of example attack patterns for adversarial aerial vehicles in an example simulated multiagent adversarial scene.

FIG. 4 is a graphical representation of radar and kill zones for aerial vehicles in an example simulated multiagent adversarial scene.

FIG. 5 is an example flow for an example simulated multiagent adversarial scene.

FIG. 6 is an example cost matrix for an example simulated multiagent adversarial scene.

FIG. 7 is a graphical representation of role assignments in an example simulated multiagent adversarial scene.

FIG. 8 is a graphical representation of policies based on relative aerial vehicle positions in an example simulated mixed cooperative-competitive multiagent scene.

FIG. 9A is a graphical representation of a horizontal plane state space an example simulated multiagent adversarial scene.

FIG. 9B is a graphical representation of a vertical plane state space an example simulated multiagent adversarial scene.

FIGS. 10A and 10B show example expansion in training tactical models for an example simulated multiagent adversarial scene.

FIG. 11 is a flowchart of an example method for autonomous behaviors in a multiagent adversarial scene.

FIG. 12 is a flowchart of an example method for autonomous behaviors in a multiagent adversarial scene.

FIG. 13 is a flowchart of an example method for autonomous behaviors in a multiagent adversarial scene.

FIG. 14 is a flowchart of an example method for autonomous behaviors in a multiagent adversarial scene.

FIG. 15 is a flowchart of an example method for autonomous behaviors in a multiagent adversarial scene.

FIG. 16 is a flowchart of an example method for autonomous behaviors in a multiagent adversarial scene.

### DETAILED DESCRIPTION

A multiagent adversarial scene is a scenario in which one or more friendly agents attempt to reach a defined win condition and prevent lose conditions. The one or more friendly agents are opposed by one or more adversarial agents attempting to reach their own defined win condition and prevent their own lose conditions. Often, the lose conditions of the friendly agents are identical, or equivalent, to the win condition of the adversarial agents, implying a zero sum game. In other scenarios, the opposing win and lose conditions form a general sum game. Additionally, in some scenarios, agents may have hierarchies of win and/or lose conditions (e.g., acceptable loss).

In the context of the multiagent adversarial scene, a friendly agent is a decision making autonomous agent, application, or module configured to determine behavioral actions for an agent device. The autonomous agent may be implemented as a software agent, a hardware agent, or combinations thereof. For example, the agent device may comprise a drone or other unmanned aerial vehicle (UAV), another autonomous vehicle, or another entity. Where the multiagent adversarial scene is a simulated multiagent adversarial scene, the agent device may include a simulated instance of an agent device maneuvering or operating in a simulated space. The adversarial agents referred to herein may include agents controlling adversarial agent devices, agents controlling simulated agent devices, human- or user-operated devices, adversarial agent devices themselves (simulated or not), and the like. References to agents (friendly or adversarial) in a physical or simulated space may be considered references to the corresponding agent device in physical or simulated space. In other words, in the context of physical locations, placement, distances, and the like in an environment, an “agent” and “agent device” may be referred to interchangeably. For example, a position of a friendly agent relative to an adversarial agent would be construed to mean the position of the friendly agent device relative to the adversarial agent device in physical or simulated space.

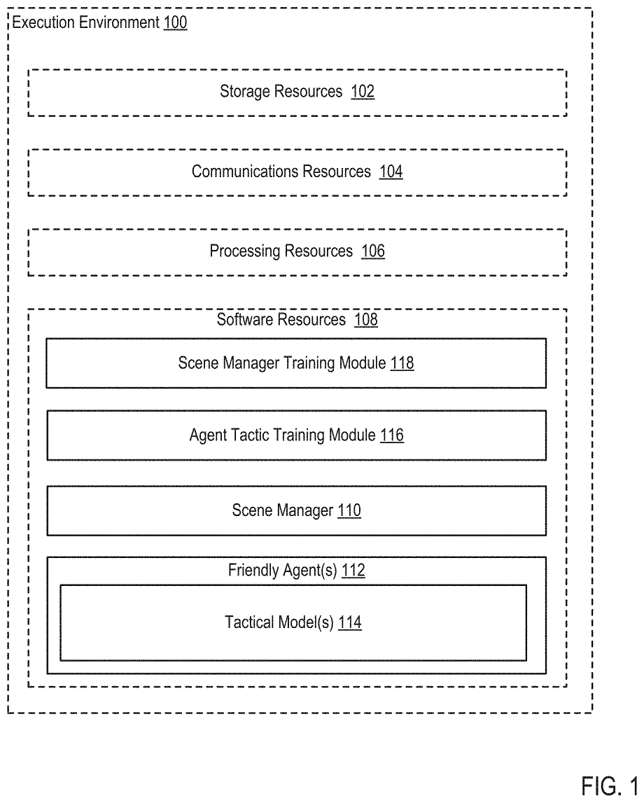

Embodiments for autonomous behaviors in a multiagent adversarial scene may be implemented in an execution environment. Accordingly, FIG. 1 sets forth a diagram of an execution environment 100 accordance with some embodiments of the present disclosure. The execution environment 100 depicted in FIG. 1 may be embodied in a variety of different ways. The execution environment 100 may be provided, for example, by one or more cloud computing providers such as Amazon AWS, Microsoft Azure, Google Cloud, and others, including combinations thereof. Alternatively, the execution environment 100 may be embodied as a collection of devices (e.g., servers, storage devices, networking devices) and software resources that are included in a private data center. In fact, the execution environment 100 may be embodied as a combination of cloud resources and private resources that collectively form a hybrid cloud computing environment. Readers will appreciate that the execution environment 100 may be constructed in a variety of other ways and may even include resources within one or more autonomous devices (e.g., agent devices) or resources that communicate with one or more autonomous devices.

The execution environment 100 depicted in FIG. 1 may include storage resources 102, which may be embodied in many forms. For example, the storage resources 102 may include flash memory, hard disk drives, nano-RAM, 3D crosspoint non-volatile memory, MRAM, non-volatile phase-change memory (‘PCM’), storage class memory (‘SCM’), or many others, including combinations of the storage technologies described above. Readers will appreciate that other forms of computer memories and storage devices may be utilized as part of the execution environment 100, including DRAM, SRAM, EEPROM, universal memory, and many others. The storage resources 102 may also be embodied, in embodiments where the execution environment 100 includes resources offered by a cloud provider, as cloud storage resources such as Amazon Elastic Block Storage (‘EBS’) block storage, Amazon S3 object storage, Amazon Elastic File System (‘EFS’) file storage, Azure Blob Storage, and many others. The example execution environment 100 depicted in FIG. 1 may implement a variety of storage architectures, such as block storage where data is stored in blocks, and each block essentially acts as an individual hard drive, object storage where data is managed as objects, or file storage in which data is stored in a hierarchical structure. Such data may be saved in files and folders, and presented to both the system storing it and the system retrieving it in the same format.

The execution environment 100 depicted in FIG. 1 also includes communications resources 104 that may be useful in facilitating data communications between components within the execution environment 100, as well as data communications between the execution environment 100 and computing devices that are outside of the execution environment 100. Such communications resources may be embodied, for example, as one or more routers, network switches, communications adapters, and many others, including combinations of such devices. The communications resources 104 may be configured to utilize a variety of different protocols and data communication fabrics to facilitate data communications. For example, the communications resources 104 may utilize Internet Protocol (‘IP’) based technologies, fibre channel (‘FC’) technologies, FC over ethernet (‘FCoE’) technologies, InfiniBand (‘IB’) technologies, NVM Express (‘NVMe’) technologies and NVMe over fabrics (‘NVMeoF’) technologies, and many others. The communications resources 104 may also be embodied, in embodiments where the execution environment 100 includes resources offered by a cloud provider, as networking tools and resources that enable secure connections to the cloud as well as tools and resources (e.g., network interfaces, routing tables, gateways) to configure networking resources in a virtual private cloud. Such communications resources may be useful in facilitating data communications between components within the execution environment 100, as well as data communications between the execution environment 100 and computing devices that are outside of the execution environment 100 (e.g., computing devices that are included within an agent device).

The execution environment 100 depicted in FIG. 1 also includes processing resources 106 that may be useful in useful in executing computer program instructions and performing other computational tasks within the execution environment 100. The processing resources 106 may include one or more application-specific integrated circuits (‘ASICs’) that are customized for some particular purpose, one or more central processing units (‘CPUs’), one or more digital signal processors (‘DSPs’), one or more field-programmable gate arrays (‘FPGAs’), one or more systems on a chip (‘SoCs’), or other form of processing resources 106. The processing resources 106 may also be embodied, in embodiments where the execution environment 100 includes resources offered by a cloud provider, as cloud computing resources such as one or more Amazon Elastic Compute Cloud (‘EC2’) instances, event-driven compute resources such as AWS Lambdas, Azure Virtual Machines, or many others.

The execution environment 100 depicted in FIG. 1 also includes software resources 108 that, when executed by processing resources 106 within the execution environment 100, may perform various tasks. The software resources 108 may include, for example, one or more modules of computer program instructions that when executed by processing resources 106 within the execution environment 100 are useful in autonomous behaviors in a multiagent adversarial scene. For example, a scene manager 110 may be configured to assign a role to each of one or more friendly agents 112. In this example, each friendly agent 112 may be implemented by a subset of the processing resources 106. For example, each friendly agent 112 may have a dedicated processor, multiple dedicated processors, or individual processors may each be used to implement multiple friendly agents 112. A role for a friendly agent 112 comprises one or more objectives in the context of the multiagent adversarial scene. For example, a role of a friendly agent 112 may comprise engaging one or more designated adversarial agents. A friendly agent 112 is considered engaged with an adversarial agent when the adversarial agent's agent device is a target for one or more actions determined by the friendly agent 112 and performed by a corresponding friendly agent device. Such actions may include destroying the agent device, obstructing movement of the agent device, and the like. As another example, a role of a friendly agent 112 may include protecting a high value asset, remaining in reserves or a designated area of a space or engagement zone, and the like. As set forth above, the execution environment 100 may be implemented in a combination of devices, including servers, cloud resources, and autonomous devices. As an example, a scene manager 110 may be implemented using servers, cloud resources, or other computing resources, while friendly agents 112 may each be implemented in an autonomous device (e.g., an agent device).

A multiagent adversarial scene (or “scene”) comprises the totality of all agents (friendly and adversarial) and the totality of their associated states and observations. A sub-scene as referred to herein is a functional subunit of the scene. Each sub-scene is treated as being functionally independent. Sub-scenes for a given scene may include each grouping of friendly agents 112 assigned to a same role (e.g., assigned to engage the same one or more adversarial agents, assigned to defend a high value asset, and the like). As an example, assume a four-versus-two scene where four friendly agents 112 are opposing two adversarial agents. Further assume that two friendly agents 112 are assigned to engage a first adversarial agent, and two other friendly agents 112 are assigned to engage a second adversarial agent. The two friendly agents 112 and the first adversarial agent would be logically grouped into a first sub-scene, while the other two friendly agents 112 and the second adversarial agent are logically grouped into a second sub-scene. In other words, assigning a friendly agent 112 to a particular role effectively assigns the friendly agent 112 to a particular sub-scene. Each sub-scene may also include observations (e.g., by the friendly agents 112 and their corresponding agent devices) in the environment relative to the included agents (e.g., relative to their corresponding agent devices). Observations of a given entity may include the determined or perceived position, velocity, and the like of the given entity and/or the determined or perceived positions, velocities, and the like of other entities in the sub-scene (e.g., relative to the given entity). Using the example above, a sub-scene may include a predefined area relative to (e.g., centered around) an adversarial agent device.

Assigning a role to a friendly agent 112 may comprise calculating a plurality of costs. The plurality of costs may each correspond to a role of one or more roles (e.g., a cost for each possible combination of assigning each role to each particular friendly agent 112). A role is then selected based on the costs. For example, for each friendly agent 112, a cost may be calculated for engaging the friendly agent 112 with each possible adversarial agent. The plurality of costs may be expressed as a table or matrix, with one dimension corresponding to friendly agents 112 (e.g., rows) and another dimension (e.g., columns) corresponding to an adversarial agent engagement. As another example, where two friendly agents 112 may be assigned to engage with one adversarial agent, the plurality of costs may be calculated for each possible pair of friendly agents 112 and each adversarial agent. One skilled in the art would appreciate that the number of possible roles and corresponding costs may vary depending on the number of possible configurations for engagement (e.g., 1v1, 2v1 . . . MvN).

The scene manager 110 may assign roles based on one or more rules for engagement with adversarial agents. Assuming that the scene manager 110 is restricted to particular configurations for engagement, where the number of friendly agents 112 greatly exceeds the number of adversarial agents, there may be a threshold number of possible friendly agents 112 to assign an engagement role. As an example, where eight friendly agents 112 are opposed by two adversarial agents and the scene manager 110 is restricted to 1v1 and 2v1 engagement configurations, at most four friendly agents 112 can be assigned to engage an adversarial agent. Accordingly, four friendly agents 112 may be assigned a non-engagement or default role (e.g., defense, reserve, and the like). Readers will appreciate that the scene manager 110 is not necessarily restricted to 1v1, 2v1, or any particular engagement configuration. For a given MvN engagement scenario, the scene manager 110 may decompose the MvN scene into a combination of k engagements of the form M₁×N₁ . . . Mₖ×Nₖ where Mᵢ≤M, Nᵢ≤N for all 1≤i≤k. This formulation also supports cases in which the same target agent may be assigned to more than one group of engaging agents.

The cost function used to calculate the cost of a particular assignment may be tuned depending on the particular multiagent adversarial scene. The cost function may be based on distance between agents, weighted linear combinations of costs, and the like. Specific examples of cost functions will be described in further detail below in the discussion of the example multiagent adversarial scene set forth herein.

The scene manager 110 may also reassign a role of a friendly agent 112 in response to a particular event. The particular event may correspond to a change in spatial, tactical, or strategic conditions. For example, the scene manager 110 may determine whether to reassign a role of the friendly agent 112 in response to an agent (friendly or adversarial) being removed from the scene (e.g., destroyed, retreated or left a designated space, and the like), a new agent (friendly or adversarial) being introduced to the scene (e.g., entering a designated space), a friendly agent 112 meeting a risk condition (e.g., at risk of being eliminated or destroyed). The particular event may also correspond to an occurrence or passage of a predefined interval (e.g., a predefined number of timestamps or steps).

In response to the event occurring, the scene manager 110 may calculate the costs of current role assignments and compare these calculated costs to a utility value of another assignment (e.g., a new optimal assignment). The utility value may comprise the costs of the new assignment and/or other values. If a ratio of the current costs to the utility value are over a threshold, the friendly agents 112 are reassigned according to the new optimal assignment.

After assigning roles to the friendly agents 112, the scene manager 110 assigns a policy to the friendly agents 112. Each role is associated with one or more policies. For example, a non-engagement role may only include one policy, while an engagement role may be associated with multiple policies. The policy of a friendly agent 112 determines which tactical model 114 will be used by the friendly agent 114 in order to determine actions during operation. Determined actions include actions to be taken by a particular agent and/or agent device, such as movement actions (e.g., moving in a particular direction, moving at a particular speed or velocity, and the like), activating weapons or other components. The determined actions are sent to the corresponding agent devices to effect the determined actions (e.g., execute operations to perform the determined actions). For example, the friendly agents 112 may provide the determined actions to an asset management layer (not shown) to generate executable operations that are transmitted to the corresponding agent devices. In simulated multiagent adversarial scenarios, the control layer may update a position, placement, and the like of a simulated agent device in simulated space. Each tactical model 114 comprises a trained machine learning model (e.g., a trained neural network, and the like) and reward function for determining actions based on the observations of the corresponding friendly agent 112, as will be described in further detail below.

The choice of policy for one or multiple friendly agent(s) 112 depends on the general configuration of the system. For example, policy selection may be determined based on a position of the friendly agent 112 relative to an engaged adversarial agent (e.g., based on a position of a friendly agent device 112 relative to an engaged adversarial agent device). For example, a first area relative to the adversarial agent may correspond to an “evasion” policy, while a second area may correspond to a “close in” policy, and the like. As each policy corresponds to a different tactical model 114, the agents 112 are considered to use “decomposed” policies. This is distinct from a unified policy where a single model is used to generate all actions. Though a unified policy is possible to implement, training the unified policy model would require a complex reward function and substantial training time. In this context, training of a model refers to reinforcement learning, including iteratively running scenarios or otherwise applying training data to the model and modifying parameters (e.g., weights) of the model to maximize a reward calculated by a reward function.

The scene manager 110 may base role and policy assignments/reassignments for friendly agents 112 based on observations from the friendly agents 112 (e.g., generated by sensors or other equipment of agent devices and transmitted via the friendly agents 112 to the scene manager 110. Accordingly, the scene manager 110 may be configured to aggregate observations from the friendly agents 112. For example, the scene manager 110 may determine policy assignments on a sub-scene level by aggregating observations from the friendly agents 112 in the sub-scene and assigning policies to these friendly agents 112 accordingly. Thus, policy assignments are determined on a sub-scene level, allowing for functionally independent policy determinations across each sub-scene.

An example flow for interactions between the scene manager 110 and friendly agents 112 is as follows: The scene manager 110 may initialize and/or reset friendly agents 112. The scene manager 110 may aggregate observations of the placement of friendly agents 112, adversarial agents, and/or other entities (e.g., high value assets). The observations may be aggregated from each friendly agent 112 based on sensors or equipment on corresponding agent devices and/or from sensors or equipment accessible to the scene manager 110 (e.g., radar or other sensors capable of sensing an entire environmental space of the multiagent adversarial scenario). The scene manager 110 then assigns roles and polices to the friendly agents.

Having been assigned policies, the friendly agents 112 determine actions by collecting observations relative to their sub-scene and providing the observations to the tactical model 114 corresponding to the assigned policy. The collected observations are also provided to the scene manager 110, which may update the assigned policy of a friendly agent 112 based on the collected observations. The friendly agents 112 provide the determined actions (e.g., via an asset management layer) to generate the corresponding control operations to effect the determined actions in the agent devices corresponding to the friendly agents 112. The friendly agents 112 continue to collect and provide observations, and determine actions based on their assigned policy until a new policy and/or role is assigned by the scene manager 110, or until the friendly agent 112 accomplishes its task or is eliminated (e.g., by destruction or elimination of an agent device, and the like).

An agent tactic training module 116 may train the tactical models 114. For example, each role (e.g., engagement configuration) and policy combination corresponds to a particular tactical model 114. To ensure coverage with respect to the entire state space of a given sub-scene, simulated friendly agent(s) 112 are placed in an environment of a simulated state space relative to a simulated adversarial agent. For example, simulated friendly agent(s) 112 may be placed in a simulated state space according to some initial condition. For example, the simulated friendly agent(s) 112 may be placed randomly, or randomly relative to another object. As an example, the simulated friendly agent(s) 112 may be randomly placed in a coordinate system centered on a simulated adversarial agent. The simulation is then run. Friendly agent 112 placement and simulations are repeatedly performed until a termination condition is met (e.g., convergence to meeting desired criteria, or a maximum number of steps or iterations are performed). In some embodiments, the simulated friendly agent(s) are placed within a constrained area within the simulated state space (e.g., close to an engaged adversarial agent). The constrained area may be expanded over time in order such that the tactical models 114 are trained within easier constraints first, then with broader constraints and more computationally complex simulations later.

The scene manager 110 may operate using various hyperparameters defining operational attributes of the scene manager, thresholds, and the like, as well as hyperparameters for any implemented learning models (e.g., learning rate, discount facture, overall structure, and the like), such as for a neural network. The term “hyperparameter” in this configuration refers to any attribute or parameter that is preset or predefined for use by the scene manager 110 in performing the determinations described herein. The scene manager 110 may be trained by a scene manager training module 118. The scene manager training module 118 may run multiple simulations of multiagent adversarial scenes using various combinations of hyperparameters and evaluate the performance of the simulations using various metrics (e.g., friendly agent 112 victories, adversarial agent victories, elimination rates for friendly or adversarial agents, and the like). The optimal combination of hyperparameters may then be used by the scene manager 110.

The scene manager 110 provides a highest level for observing the full world, assigning roles, and invoking appropriate policies and models. The middle level provided by friendly agents 112 controls invoking policies through the execution of their mission via the designated tactical model 114. The asset management layer (not shown) is abstracted to focus on the remaining two layers. The layered approach described herein provides several advantages. The entire hierarchy can be ported to different platforms by switching out the asset management layer of the hierarchy. Another advantage is training efficiency. Each layer can be trained individually and independently of the others, thereby reducing the action space that must be considered for learning a policy for that level. Moreover, tactical models 114 may be trained on the sub-scene level, further reducing the action space and training space.

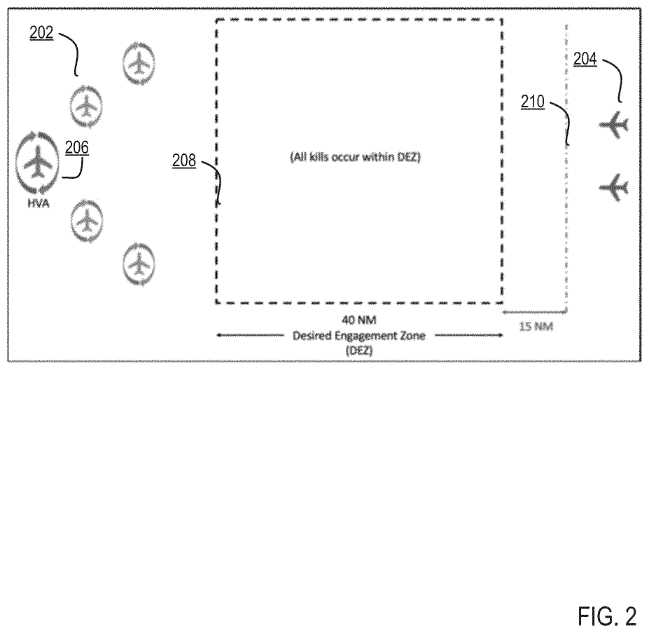

For further explanation of autonomous behaviors in a multiagent adversarial scene, FIGS. 2-10B describe an example implementation of embodiments for autonomous behaviors in a multiagent adversarial scene within the context of an example simulated multiagent adversarial scene. FIG. 2 provides a graphical representation of the example simulated multiagent adversarial scene. In this example scene, eight friendly aerial vehicles 202 are opposed by two adversarial aerial vehicles 204. Both the friendly aerial vehicles 204 and adversarial aerial vehicles 204 comprise agent devices (e.g., drones, UAVs) controllable by respective agents. For clarity purposes, only four friendly aerial vehicles 202 are shown.

The example scene comprises a defensive counter-air (DCA) mission where the friendly aerial vehicles 202 defend an airborne high value asset (HVA) 206 against the adversarial aerial vehicles 204. A desired engagement zone (DEZ) 208 is defined in which the friendly aerial vehicles 202 attempt to engage the adversarial aerial vehicles 204 prior to the adversarial aerial vehicles 204 reaching the HVA 206.

In the example scene described below, various examples of parameters, attack patterns, and other attributes are described. It is understood that these merely serve as examples to further illustrate the example scene, and do not confer or imply any restrictions, limitations, or requirements for the teachings set forth in the present disclosure.

It is assumed that a scene manager 110 is aware of the adversarial aerial vehicles 204 by way of a notational surface-based or airborne early warning radar and receive datalink tracks akin to Link 16. Friendly aerial vehicles 202 will not engage until the adversarial aerial vehicles 204 cross a designated threshold 210, at which point a scene manager 110 assigns roles and policies to the friendly agents 112 controlling the friendly aerial vehicles 202 to engage within the DEZ 208.

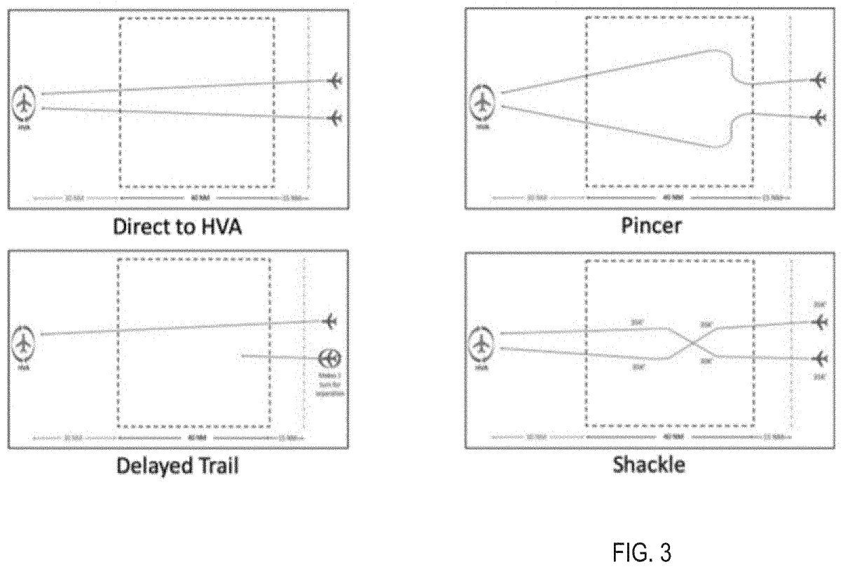

In this example scene, all aerial vehicles begin at 35,000 feet but may change altitude as necessary to avoid being shot down or to engage opposing vehicles. Moreover, in this example, airspeeds for aerial vehicles are fixed and are user configurable. The adversarial aerial vehicles 204 are programmed to fly one of four attack patterns of varying complexity, as shown in FIG. 3, and their goals are to reach the HVA 206 and avoid being shot down by friendly aerial vehicles 202. The four attack patters are as follows: Direct to HVA—adversarial aerial vehicles 204 fly directly from their starting location to the HVA 206; Pincer—adversarial aerial vehicles 205 initially fly directly to the HVA 206, turn 90 degrees away from each other, and then turn back towards the HVA 206; Delayed Trail—adversarial aerial vehicles 204 fly directly to the HVA 206. One does a descending 360 degree turn to create trail separation between the adversarial aerial vehicles 204, then continue flying towards the HVA 206; Shackle—adversarial aerial vehicles fly directly to the HVA 206 and then cross to opposite sides, forming an “X” in the sky. After achieving separation between themselves, both turn back towards the HVA 206. It is understood that these attack patterns are merely exemplary in the context of the example scenario, and that other attack patterns may be used. Moreover, it is understood that the teachings described herein are applicable to other approaches for engagement and are not limited to attack patterns.

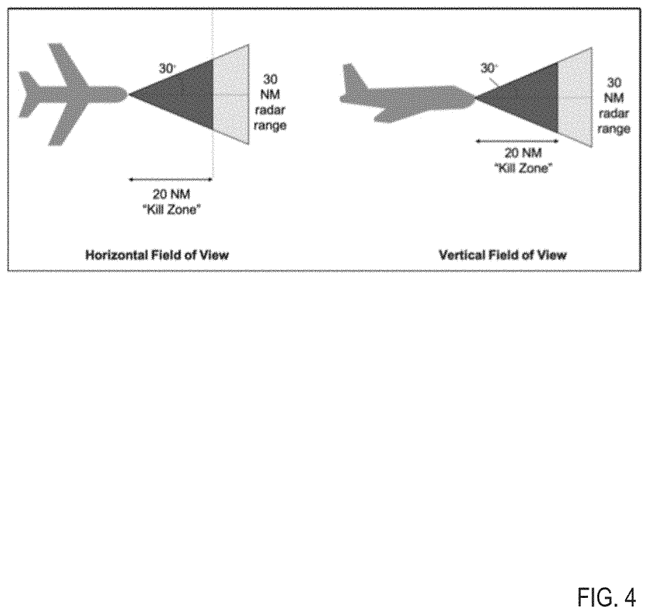

In this example, friendly aerial vehicles 202 and adversarial aerial vehicles 205 have identical radar and weapons capabilities. Each has a radar field of regard (FOR) that extends out to 30 N<within 30 degrees on either side of the nose and +−30 degrees of elevation. Within this exists a “kill zone” defined as a cone of the radar FOR out to 20 NM. FIG. 4 provides a visual depiction of the radar and kill zones.

If an aerial vehicle enters an opposing aerial vehicle's radar FOR between 20 NM and 30 NM, it is considered in danger and will need to take evasive action to leave the radar cone before entering the kill zone. In this example scenario, friendly aerial vehicles 202 can execute any maneuver to escape but adversarial aerial vehicles 204 are limited to a 45 degree right or left turn while climbing or descending, as necessary. After exiting a radar FOR, adversarial aerial vehicles 204 will turn back towards the HVA 206 and continue their assigned mission.

If an aerial vehicle enters an opposing kill zone, a simulated missile is launched with an assumed 100-percent destruction rate. Friendly aerial vehicles 202 will attempt to place adversarial aerial vehicles 204 within their kill zones, but adversarial aerial vehicles 204 are only concerned with reaching the HVA 206 and not being shot down. Therefore, friendly aerial vehicles 202 will only be destroyed if they enter an adversarial aerial vehicles 204 kill zone while attempting to engage.

Each instance of the example scenario ends with a victory for either side. Friendly victory is defined by destroying both adversarial aerial vehicles 204 or forcing them out of the DEZ 210. Adversarial victory is when either adversarial aerial vehicles 204 reach the HVA 206 and places it within their kill zone.

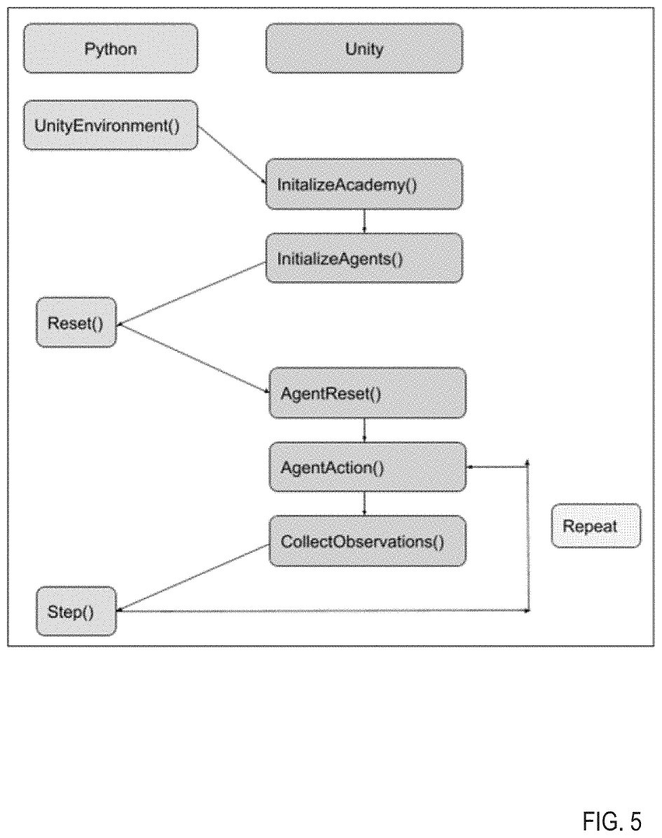

FIG. 5 shows an example flow for the example simulated multiagent adversarial scene. The Unity-MLAgents application program interface (API) was used as the reinforcement learning (RL) platform to enable interaction between the Unity application and the Python program that drives testing of learned behaviors. Unity provides the simulation environment where “learning” agents move in their respective environments depending on input from the Python code. The Python API includes several important components that make this RL testing environment possible. First, a Unity application is opened that initializes a communication protocol to set up an MLAgents training environment. The Unity application is set up as an RL training environment, where the environment has knowledge of the number of agents being trained. The communication infrastructure allows observations and actions to be passed to and from the Unity application. A reset function is called on the environment and returns the initial observations of each agent. The Unity reset function is triggered by the Python API reset function and initializes the agents in the environment based on predetermined criteria. The Python API reset function calls a Unity CollectObservations function that retrieves observations from all agents and returns the observations to the Python side. It is understood that the architecture of FIG. 5 is merely an example architecture, and that other architectures may also be used.

Once initial observations are collected, they are passed into the training model and the RL algorithm model takes observations and returns a list of actions for each agent in the environment. These actions are passed into the step function, where Unity applies those actions to each agent in the scene through an AgentAction function. Each agent then calls the CollectObservations function again, returning observations after applying the actions provided by the Python side. Finally, the step function returns the observations, a done flag (Boolean for whether a terminating condition was reached), a dictionary of extra information, and the reward achieved by the agent. The step function is constantly called until a set number of episodes is reached or a termination command is received by the Unity side.

Within the context of this example simulated multiagent scenario, the strategic level is handled by the scene manager 110, which serves as the “center of operations” for the friendly agents 112. The primary functions of the scene manager 110 are processing the joint data observation and assigning tasks to subsets of friendly agents 112, as well as instructing the friendly agent 112 subsets on which learned policies should be used to achieve their goals.

The role assignment module of the scene manager 110 allocates tasks to the friendly agents 112 controlling friendly aerial vehicles 202. As adversarial aerial vehicle 204 threats are observed, the scene manager 110 incorporates information including the current aircraft positions, orientations and velocities of all agents in the scene to decide which friendly agents 112 should engage which targets, and which friendly agents 112, if any, should remain back to protect the HVA 206. This assignment process is performed whenever a significant event occurs (e.g. an aerial vehicle is shot down, a new aerial vehicle enters the scene) or when the current assignment becomes substantially suboptimal and necessitates an update.

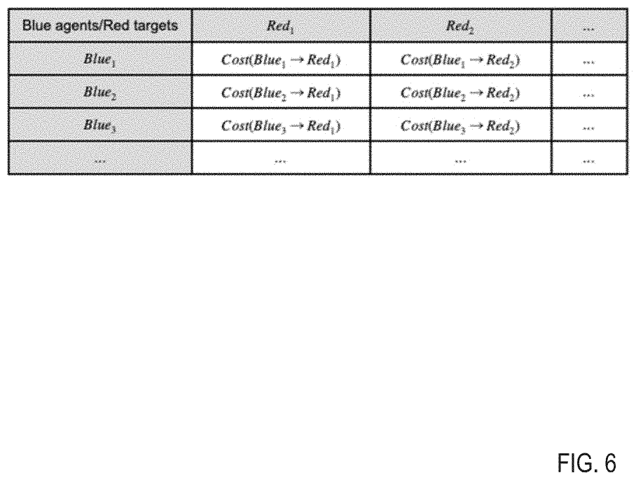

In order to assign friendly agents 112 to targets, the scene manager 110 computes a cost matrix with row indices representing friendly agents 112 and column indices reflecting adversarial aerial vehicle 204 targets. The values of each matrix cell represent the projected cost of friendly agent 112 i intercepting target j. An illustration of the cost matrix structure is provided in FIG. 6. In FIG. 6, the term “Blue” designates a friendly agent 112 and “Red” designates an adversarial aerial vehicle 204 target.

Example measures for evaluating Cost(Blueᵢ→Redᵢ) are as follows: Euclidean distance—This measure is the most straightforward and easy to compute. It does not, however, consider orientations and velocities and is therefore a substantial oversimplification, limiting its usefulness; Projective distance: Rather than considering momentary positions, this measure uses orientations and velocities to extrapolate future position in k steps. It then uses that estimate to determine what the assignment is likely to cost. While this method has its benefits, it also suffers from the limitation in that it assumes agents' orientations and velocities will remain the same; Weighted linear combination of costs: This measure is the default in the project framework. It breaks down various geometric and strategic properties of a potential assignment, such as distance, aspect angle, position relative to the opponent's kill zone, and inducement of pincer movement. It then weights them appropriately to generate a unified score. While this approach requires tuning, it offers the most flexibility and makes the fewest assumptions about opponent and teammate behavior.

In the current representation, the overall cost is of the general form φ·C _{φ}+ [symbol] +d C_{d}+ξ·C_{ξ} where φ, [symbol] , d, and ξ are the extent of pincer movement inducement, angular distance, metric distance, and kill zone exposure, respectively, for a given pairing, and the C values are preconfigured coefficients for these properties.

To enable the assignment of more than one friendly agent 112 to a target, columns are scalable to account for the maximum number of friendly agents 112 that can be assigned to a target and the current proportions of aerial vehicles on opposing sides. Though the role assignment module can fully support other agent groupings, this project focused on two types of assignments: one friendly agent 112 versus one target (1v1) and two friendly agents 112 versus one target (2v1).

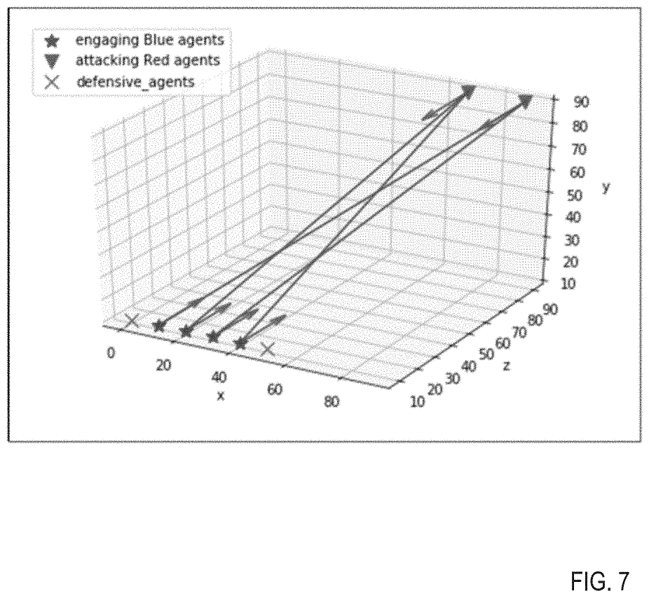

Once the cost matrix is calculated, assignment is optimally derived using an extension to the Hungarian method, a combinatorial optimization algorithm which solves the assignment problem and runs efficiently in time polynomial in the number of tasks and agents (in this case, the total number of agents). For cases in which agents remain unassigned, they are given defensive roles. At this point a full assignment is generated, as illustrated in FIG. 7.

After the role assignment step is complete, the scene manager 110 connects the appropriate control policy with each friendly agent 112 role assignment. The combination of a role assignment and a control policy forms the sub-scene, characterized by its own independent subset of agents, states, observations, and actions. This breakdown of the entire scene into independent and largely autonomous sub-scenes allows not only greater flexibility in learning and generalizing appropriate behaviors, but also allows the framework to function in decentralized and partially observable situations. The matching of assignments to policies enables the flexibility required for invoking the right behavior under the right circumstances, while being agnostic to the rest of the scene.

In the context of the strategy level, each agent does not need to obtain observations from the scene in its entirety. In fact, each agent individually does not need to observe anything besides its sub-scene teammates and opponents. Assuming friendly agents 112 have full access to each other's assigned policies, they also do not need to continually communicate between themselves. However, in this example, the assumption is that the scene manager 100 can piece together a complete observation of the entire scene (i.e. all active agents within the DEZ 208), and that the scene manager 110 can communicate efficiently with each friendly agent 112 when it needs to. The scene manager 110 and general framework architecture are amenable to more sophisticated and complex communication models.

The scene manager 110 continually monitors the entire scene and decides when a new role assignment is required for friendly agents. Reassignment may be performed in response to an event representing a tactical, strategic, or spatial change in the scenario. For example, this is done in response to: Significant change—an aerial vehicle is destroyed, a new aerial vehicle enters the scene, a friendly aerial vehicle 202 is in a danger state (e.g., at risk of being shot down), and the like; Periodic evaluation—After every T timesteps, the scene manager 110 considers the current costs of the existing assignment and compares it to the utility of a new optimal assignment. If the ratio is above a certain configurable threshold, representing sufficient improvement, the agents will be reallocated according to the new optimal assignment.

The tactical level is the layer at which intercept policies and missions are executed. As described previously, for a scenario including M friendly agents 112 vs. N adversarial agents, the scene manager 110 divides the friendly agents 112 into groups of M′ friendly agents 112 (where M′ is less than or equal to M) targeting N′ adversarial agents (where N′ is less than or equal to N). For example, the scene manager 110 divides the friendly agents 112 into groups of two friendly agents 112 versus target or one friendly agents 112 versus one target. Each of these groups operates in its own sub-scene, which is a partition of the overall scene and treated as an independent environment.

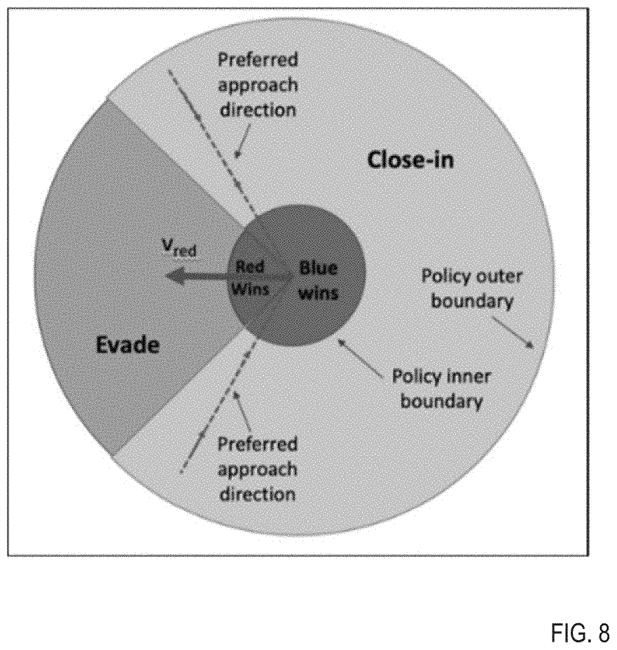

A friendly agent's 112 mission is to navigate its corresponding friendly aerial vehicle 202 to the target adversarial aerial vehicle 204 and get sufficiently close to fire a missile. From the perspective of the friendly agents 112, the adversarial aerial vehicle 204 is the center of the sub-scene and the space around it is divided into sectors as shown in FIG. 8. Again, the term “Blue” is used to describe friendly agents 112 and their friendly aerial vehicle 202 positions, while “Red” is used to describe the adversarial aerial vehicle 204. Directly in front of each adversarial aerial vehicle 204 is a three-dimensional cone labeled “Red Wins” and every friendly aerial vehicle 202 caught within that cone is guaranteed to be shot down. In a similar way, a “Blue Wins” region surrounds each adversarial aerial vehicle 204 and when a friendly aerial vehicle 202 enters that sector, the adversarial aerial vehicle 204 is guaranteed to be shot down. Beyond the outer boundary of Red Wins is the “Evade” region, and a friendly aerial vehicle 202 within it is considered to be in a risky situation and should first try to escape that region. The complementary outer region is the “Close-In” region where the friendly aerial vehicle 202 should maneuver to attack the adversarial aerial vehicle 204.

Assuming opposing aerial vehicles begin the scene facing each other, the reward function is shaped in such a way to induce a preferred attack angle. As a non-limiting example, the preferred attack angle may be 45°. Additionally, the problem is decomposed such that a different policy is trained for the “Evade” region versus the “Close-In”, or engage, region. A unified wrapping policy is then used to decide which of the two policies should be invoked based on the position of the aerial vehicles, such that the friendly agent 112 can act coherently over time without incurring model swapping costs. Initially, once assigned an attacking role by the scene manager 110, attacking friendly agents 112 fly their friendly aerial vehicles 202 directly towards their intercept target. Once within range, the trained policies are activated and begin guiding the friendly agent 112 actions. The policy disengages if the friendly agent 112 is reassigned to a target that is out of policy range or to a defensive role, when a friendly aerial vehicle 202 is shot down, or when the scenario ends.

The purpose of RL is to train a policy that outputs agent actions depending on the state of the agent and environment. In this way, a unified policy is a unique policy defined over the entire state space. Complex control is more difficult to express with a unified policy, especially if the agent is expected to display qualitative behavior differences depending on the state.

It is not impossible to train a unified policy, for example with a complex reward function and a substantial amount of training time, but it is easier to rely on a decomposition principle and train policies for subsets of specialized behaviors. To this end, the policies are divided into two subsets, one for when the friendly aerial vehicle 202 finds itself in the Evade region (referred to as the “IN” policy) and one for when the friendly aerial vehicle 202 is in the Close-In region (“OUT” policy).

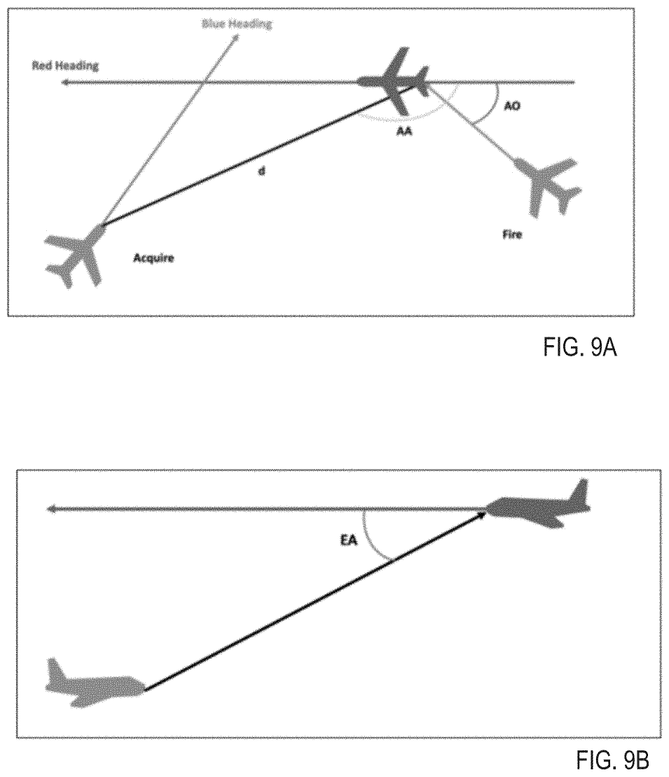

In this example scene, the state space is defined by the horizontal and vertical planes according to FIGS. 9A and 9B. In the horizontal plane, d is the distance between the friendly aerial vehicle 202 and the target. The aspect angle (AA) refers to the angle measured horizontally the flight direction of the target adversarial aerial vehicle 204 measured from the tail to the friendly aerial vehicle 202 position, independent of the friendly aerial vehicle 202 heading. Angle off (AO) is the angle between the friendly aerial vehicle 202 heading and the target's heading, measured from the latter. In the vertical plane, elevation angle (EA) is the angle measured vertically from the target to the friendly aerial vehicle 202.

The set {d, AA, AO}, along with EA if three-dimensional, provides a description of the state. For two agents, the set becomes {dₐ₁, AAₐ₁, AOₐ₁, dₐ₂, AAₐ₂, AOₐ₂}, with additional EAₐ₁, EAₐ₂ for three dimensionality. {d, AA, AO} provides a local description suited to sub-scenes and in a reference frame centered on the target. It is not affected by translations and rotations in the global space. It is understood that this is merely one example for a workable state representation, and that other state representations exist. For example, an image representation of the scene, a matrix representation, or a vector representation can be used.

Velocity norms are not included in the state. The policy only cares about positions and orientations and will thus be able to handle agents and targets with various speeds. Even if an adversarial aerial vehicle 204 velocity is significantly greater than that of the friendly aerial vehicle 202, the friendly agent 112 will still attempt to evade or close in.

Reinforcement learning relies on the principle of maximizing a reward function, or in this example, the expected discounted cumulative reward, which is defined over the state space variables. In the 1v1 policy, the reward is R=R(d, AA, AO). For the 2v1 policy, the reward takes a general form R=R(dₐ₁, AAₐ₁, AOₐ₁, dₐ₂, AAₐ₂, AOₐ₂). Special cases are R=r_{win}>>1 when the friendly aerial vehicle 202 enters the Blue Wins region and R=rₗₒₛₛ<<0 when the friendly aerial vehicle 202 enters the Red Wins region.

The complete reward function can be factorized as R=Ra1*Ra2 with Ra1, Ra2 of the form f_{d}(d) provides a strong incentive for the friendly agent 112 to maneuver the friendly aerial vehicle 202 to get closer to the target if in Close-In region and a weak incentive if in the Evade region. The term f_{AA}(AA) represents the incentive for Blue to align its movement along the preferred approach direction (AA_{best}) if in Close-In and a strong incentive to evade when in Evade. Lastly, the term f_{AO}(AO) provides incentive to orient the friendly aerial vehicle 112 velocity toward the target if in Close-In or to point to the shortest escape route when in Evade. Multiple analytical forms for f_{d}, f_{AA} and f_{AO} were explored for each IN policy, OUT policy, and UNIFIED policy case, and all return values between 0 and 1. It is understood that this is merely an example reward function, and any other reward function may also be used.

The reward for the unified policy is differentiated in that the reward is defined across the entire state space but takes different analytical forms in the Evade and Close-In regions. There are no reward continuity requirements when the agent crosses from Evade to Close-In, but a constraint is that the reward will always be larger in the Close-In region along the entire frontier so the policy learns that crossing back is not rewarded. The rewards for the IN and OUT policies are qualitatively similar to the Evade and Close-In forms of the differentiated reward for UNIFIED. If the agent controlled by the IN policy exits toward the Evade region, however, the IN reward receives a large positive bonus immediately after crossing and the policy episode terminates.

Various baseline RL algorithms may be used for training tactical models 114, such as: Deep Q-Networks (DQN) (necessitates using a discrete action space); Proximal Policy Organization (PPO) using a discrete action space; PPO using a continuous action space; Soft Actor Critic (SAC) (necessitates using a continuous action space); Deep Deterministic Policy Gradient (DDPG) (a deterministic control algorithm requiring a continuous action space); Multiagent DDPG (MA-DDPG) (a deterministic, multiagent, joint learning algorithm that is an extension of DDPG, and requires a continuous action space). In this example scenario, the selected algorithm is PPO with a continuous action space, with actions defined as a vector of changes in velocity, rotation, and heading with limits of 20° on how fast the agent can turn per step.

Readers will appreciate that the advantage of the approaches described herein are achieved by decomposing any M vs. N scenario into multiple smaller M′ vs. N′ sub-scenarios (M′ and N′ need not be the same across each sub-scenario). While it may be possible to train unified models for M vs. N scenarios, as M and N increase in number, the computational complexity required to train such models increases dramatically. Instead, by training for smaller sub-scenarios and decomposing a larger M vs. N scenario into sub-scenarios, the approaches described herein can be applied to any M vs. N scenario without the substantial increase in computational complexity.

The objective of training the tactical models 114 is to learn M′ vs N′ (e.g., 2v1 and 1v1) policies over the entire state space. This is done by placing each aircraft randomly in the state space and running a very large number of simulations. The policy training algorithm then combines exploration with exploitation until specific criteria are met (e.g. convergence, maximum number of steps or episodes). The intent is to cover the state space ergodically so that, when the policy is deployed, the corresponding tactical model 114 will be able to issue a valid action for any state encountered. In practice, compromises are made based on the likelihood of encountering various types of states.

To facilitate learning, initial conditions for the agent(s) are not randomly uniform across the entire state space. Training starts by first placing the agent very close to the desired goals and running iterations only from a tiny region of the state space. The allowable initial conditions are then slowly expanded towards regions further away from the goal, necessitating more complex maneuvering behavior to reach the goal. This creates an easy-to-difficult learning curriculum.

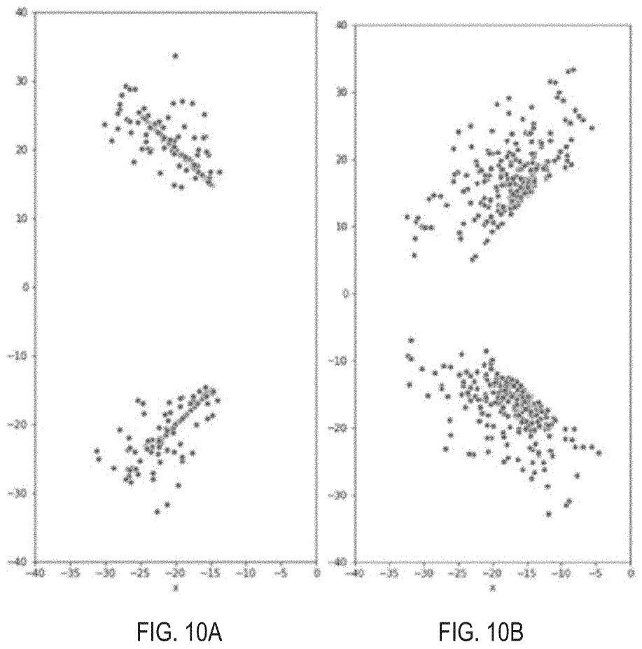

The first episode starts at the edge of the Blue Wins region from the preferred approach direction (AA_{best}), with the agent pointing directly to the target. Expansion can be carried out arbitrarily. As a non-limiting example, expansion starts in both d and AA for a large number of episodes. From there, expansion begins in AO (initial agent orientation with regard to the target velocity vector) and may overlap with the d and AA expansion. FIG. 10A shows expansion first in d along the preferred close-in direction (AA_{best}), then in AA away from AA_{best}. FIG. 10B shows expansion in both d and AA around the preferred close-in directions (AA_{best}).

Similar to the tactical-level, training runs explored various combinations of hyperparameter values for controlling the strategic-level scene manager 110. As an example of a strategic hyperparameter, throughout an episode the scene manager 110 must make a determination whether to re-assign Blue agents to different sub-scenes or roles. One hyperparameter that influences re-assignments is called the reassignment factor. When a new re-grouping of friendly agents 112 outscores the current grouping by this factor or more, the scene manager 110 will re-assign them. It is understood that this is one example of a reassignment trigger, and others may exist.

Unlike tactical-level training of tactical models 114, strategic-level training of the scene manager 110 does not produce trained models, but rather provides heuristics for the effect of hyperparameter values on friendly agent 112 behavior. These values, both individually and in combination, were evaluated on various metrics such as the probability of friendly success and the probability that a friendly aerial vehicle 202 enters the kill zone of an adversarial aerial vehicle 204. These metrics were used to select the best combination of hyperparameter values for the final configuration.

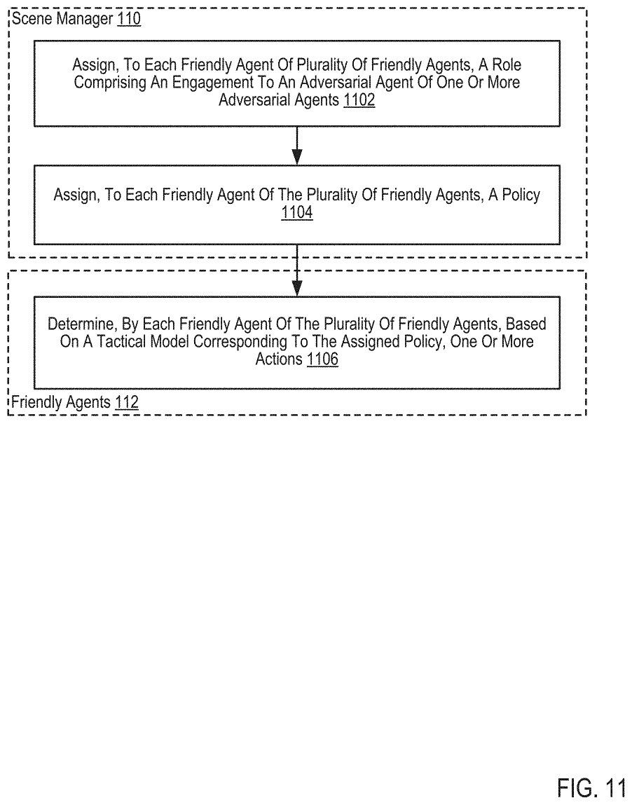

For further explanation, FIG. 11 sets forth a flow chart illustrating an exemplary method for autonomous behaviors in a multiagent adversarial scene that includes assigning 1102 (e.g., by a scene manager 110), to each friendly agent 112 of a plurality of friendly agents 112, a role comprising an engagement to an adversarial agent of one or more adversarial agents. A friendly agent 112 is considered engaged with an adversarial agent when the adversarial agent's agent device is a target for one or more actions determined by the friendly agent 112 and performed by a corresponding friendly agent device. Such actions may include destroying the adversarial agent device, obstructing movement of the adversarial agent device, and the like.

Assigning a role to a friendly agent 112 may comprise calculating a plurality of costs for one or more roles and selecting a role based on the costs. For example, for each friendly agent 112, a cost may be calculated for engaging the friendly agent 112 with each possible target (e.g., adversarial agent, adversarial agent device). As another example, where multiple friendly agents 112 may be assigned to engage with one target, the plurality of costs may be calculated for each possible pair of friendly agents 112 and each target. One skilled in the art would appreciate that the number of possible roles and corresponding costs may vary depending on the number of possible configurations for engagement (e.g., 1v1, 2v1 . . . MvN). The possible roles that may be assigned to a friendly agent 112 may be based on a predefined or limit set of possible configurations for engagement.

The method of FIG. 11 also includes assigning 1104 (e.g., by the scene manager 110), to each friendly agent 112 of the plurality of friendly agents 112, a policy. Each role is associated with one or more policies. For example, a non-engagement role may only include one policy, while an engagement role may be associated with multiple policies. Accordingly, the selection of policies that may be assigned to a given friendly agent 112 is based on the role assigned to the friendly agent 112. The policy of a friendly agent 112 determines which tactical model 114 will be used by the friendly agent 114 in order to determine actions during operation. The policies may be composites of multiple policies.

The policy for a friendly agent 112 may be determined and assigned based on various criteria. For example, the policy of a friendly agent 112 may be assigned based a position of the friendly agent 112 relative to an engaged adversarial agent (e.g., based on a position of a friendly agent device 112 relative to an engaged adversarial agent device). For example, a first area relative to the adversarial agent may correspond to an “evasion” policy, while a second area may correspond to a “close in” policy, and the like. As each policy corresponds to a different tactical model 114, the agents 112 are considered to use “composite” policies. This is distinct from a unified policy where a single model is used to generate all actions. Though a unified policy is possible to implement, training the unified policy model would require a complex reward function and substantial training time.

Policy assignments/reassignments for friendly agents 112 based on observations from the friendly agents 112 (e.g., generated by sensors or other equipment of agent devices and transmitted via the friendly agents 112 to the scene manager 110. Accordingly, the scene manager 110 may be configured to aggregate observations from the friendly agents 112. For example, the scene manager 110 may determine policy assignments on a sub-scene level by aggregating observations from the friendly agents 112 in the sub-scene and assigning policies to these friendly agents 112 accordingly. Thus, policy assignments are determined on a sub-scene level, allowing for functionally independent policy determinations across each sub-scene.

The method of FIG. 11 also includes determining 1106, by each friendly agent 112 of the plurality of friendly agents 112, based on a tactical model 114 corresponding to the assigned policy, one or more actions. For example, each friendly agent 112 may provide observations of the environment relative to its assigned sub-scene to the tactical model 114 corresponding to the assigned policy. Based on a reward function, the tactical model 114 may output one or more actions for a corresponding agent device. The actions may be effected by the agent device (e.g., movement, maneuvers, changes in velocity, and the like).

The determined actions are sent to the corresponding agent devices to effect the determined actions. For example, the friendly agents 112 may provide the determined actions to an asset management layer to generate executable operations that are transmitted to the corresponding agent devices. In simulated multiagent adversarial scenarios, the asset management layer may update a position, placement, orientation, velocity, and the like, of a simulated agent device in simulated space.

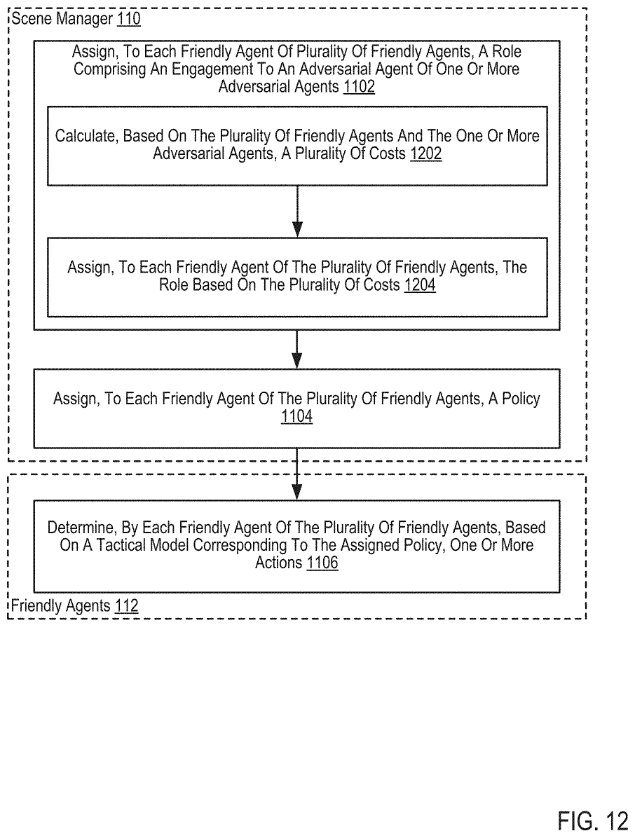

For further explanation, FIG. 12 sets forth a flow chart illustrating an exemplary method for autonomous behaviors in a multiagent adversarial scene that includes assigning 1102 (e.g., by a scene manager 110), to each friendly agent 112 of a plurality of friendly agents 112, a role comprising an engagement to an adversarial agent of one or more adversarial agents; assigning 1104 (e.g., by the scene manager 110), to each friendly agent 112 of the plurality of friendly agents 112, a policy; and determining 1106, by each friendly agent 112 of the plurality of friendly agents 112, based on a tactical model 114 corresponding to the assigned policy, one or more actions.

The method of FIG. 12 differs from FIG. 11 in that assigning 1102 (e.g., by a scene manager 110), to each friendly agent 112 of a plurality of friendly agents 112, a role comprising an engagement to an adversarial agent of one or more adversarial agents includes calculating 1202 (e.g., by the scene manager 110), based on the plurality of friendly agents 112 and the one or more adversarial agents, a plurality of costs. For example, for each friendly agent 112, a cost may be calculated for engaging the friendly agent 112 with each possible adversarial agent. The plurality of costs may be expressed as a table or matrix, with one dimension corresponding to friendly agents 112 (e.g., rows) and another dimension (e.g., columns) corresponding to an adversarial agent engagement. As another example, where two friendly agents 112 may be assigned to engage with one adversarial agent, the plurality of costs may be calculated for each possible pair of friendly agents 112 and each adversarial agent. One skilled in the art that the number of possible roles and corresponding costs may vary depending on the number of possible configurations for engagement (e.g., 1v1, 2v1 . . . MvN). The cost function used to calculate the cost of a particular assignment may be tuned depending on the particular multiagent adversarial scene. The cost function may be based on distance between agents, weighted linear combinations of costs, and the like. Specific examples of cost functions will be described in further detail below in the discussion of the example multiagent adversarial scene set forth herein. Other assignment approaches may also be used.

The method of FIG. 12 further differs from FIG. 11 in that assigning 1102 (e.g., by a scene manager 110), to each friendly agent 112 of a plurality of friendly agents 112, a role comprising an engagement to an adversarial agent of one or more adversarial agents includes assigning 1204 (e.g., by the scene manager 110), to each friendly agent of the plurality of friendly agents 112, the role based on the plurality of costs. For example, each friendly agent 112 may be assigned a target corresponding to a lowest cost for the friendly agent 112. As another example, where costs are calculated for assigning combinations (e.g., pairs) of friendly agents 112 to a given target or combinations of targets, assignments may be determined to minimize total costs while engaging all possible targets.

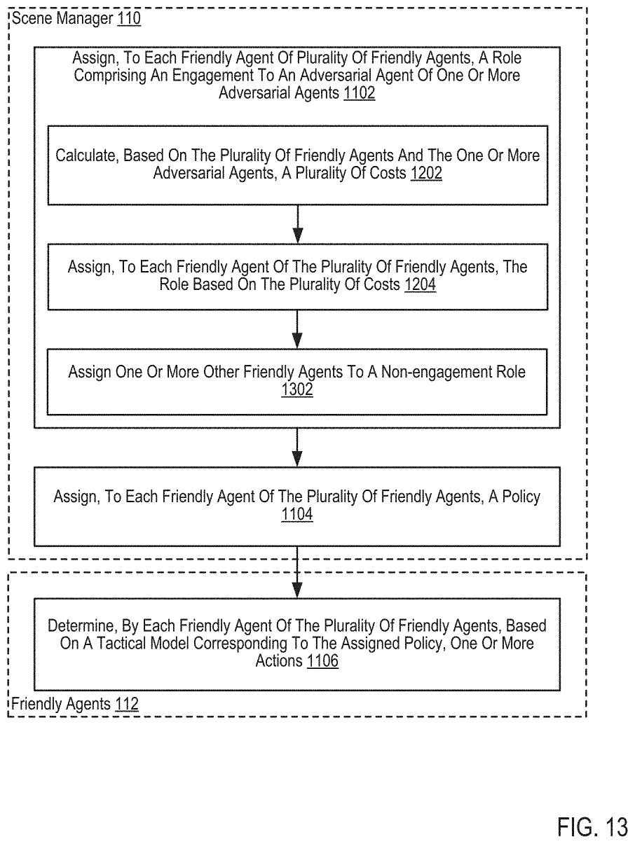

For further explanation, FIG. 13 sets forth a flow chart illustrating an exemplary method for autonomous behaviors in a multiagent adversarial scene that includes assigning 1102 (e.g., by a scene manager 110), to each friendly agent 112 of a plurality of friendly agents 112, a role comprising an engagement to an adversarial agent of one or more adversarial agents by calculating 1202 (e.g., by the scene manager 110), based on the plurality of friendly agents 112 and the one or more adversarial agents, a plurality of costs; and assigning 1204 (e.g., by the scene manager 110), to each friendly agent of the plurality of friendly agents 112, the role based on the plurality of costs; assigning 1104 (e.g., by the scene manager 110), to each friendly agent 112 of the plurality of friendly agents 112, a policy; and determining 1106, by each friendly agent 112 of the plurality of friendly agents 112, based on a tactical model 114 corresponding to the assigned policy, one or more actions.

The method of FIG. 13 differs from FIG. 12 in that assigning 1102 (e.g., by a scene manager 110), to each friendly agent 112 of a plurality of friendly agents 112, a role comprising an engagement to an adversarial agent of one or more adversarial agents includes assigning 1302 (e.g., by the scene manager 110) one or more other friendly agents 112 to a non-engagement role. The scene manager 110 may assign roles based on one or more rules for engagement with adversarial agents. Assuming that the scene manager 110 is restricted to particular configurations for engagement, where the number of friendly agents 112 greatly exceeds the number of adversarial agents, there may be a threshold number of possible friendly agents 112 to assign an engagement role. As an example, where eight friendly agents 112 are opposed by two adversarial agents and the scene manager 110 is restricted to 1v1 and 2v1 engagement configurations, at most four friendly agents 112 can be assigned to engage an adversarial agent. Accordingly, four friendly agents 112 may be assigned a non-engagement or default role (e.g., defense, reserve, and the like).

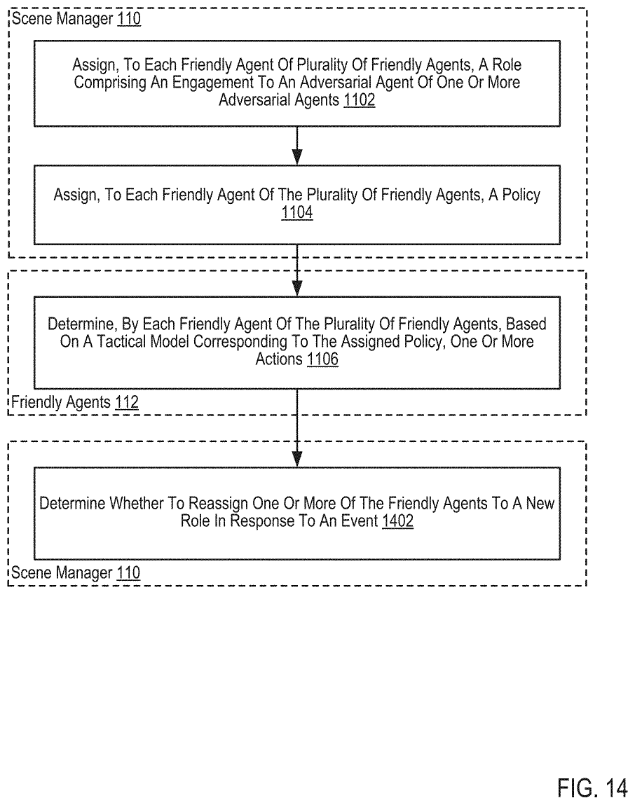

For further explanation, FIG. 14 sets forth a flow chart illustrating an exemplary method for autonomous behaviors in a multiagent adversarial scene that includes assigning 1102 (e.g., by a scene manager 110), to each friendly agent 112 of a plurality of friendly agents 112, a role comprising an engagement to an adversarial agent of one or more adversarial agents; assigning 1104 (e.g., by the scene manager 110), to each friendly agent 112 of the plurality of friendly agents 112, a policy; and determining 1106, by each friendly agent 112 of the plurality of friendly agents 112, based on a tactical model 114 corresponding to the assigned policy, one or more actions.

The method of FIG. 14 differs from FIG. 11 in that the method of FIG. 14 also includes determining 1402 (e.g., by the scene manager 110) whether to reassign one or more or the friendly agents in response to an event. For example, the scene manager 110 may determine whether to reassign a role of the friendly agent 112 in response to an agent (friendly or adversarial) being removed from the scene (e.g., destroyed, retreated or left a designated space, and the like), a new agent (friendly or adversarial) being introduced to the scene (e.g., entering a designated space), a friendly agent 112 meeting a risk condition (e.g., at risk of being eliminated or destroyed), or at a predefined interval (e.g., a predefined number of timestamps or steps).

In response to the event occurring, the scene manager 110 may calculate the costs of current role assignments and compare these calculated costs to a utility value of another assignment (e.g., a new optimal assignment). The utility value may comprise the costs of the new assignment and/or other values. If a ratio of the current costs to the utility value are over a threshold, the friendly agents 112 are reassigned according to the new optimal assignment.

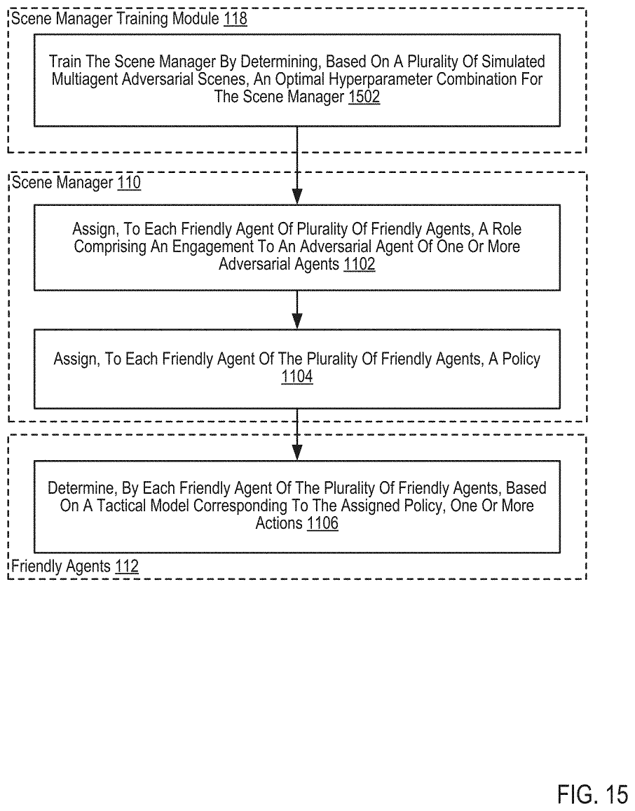

For further explanation, FIG. 15 sets forth a flow chart illustrating an exemplary method for autonomous behaviors in a multiagent adversarial scene that includes assigning 1102 (e.g., by a scene manager 110), to each friendly agent 112 of a plurality of friendly agents 112, a role comprising an engagement to an adversarial agent of one or more adversarial agents; assigning 1104 (e.g., by the scene manager 110), to each friendly agent 112 of the plurality of friendly agents 112, a policy; and determining 1106, by each friendly agent 112 of the plurality of friendly agents 112, based on a tactical model 114 corresponding to the assigned policy, one or more actions.

The method of FIG. 15 differs from FIG. 11 in that the method of FIG. 15 also includes training 1502 (e.g., by a scene manager training module 118) the scene manager 110 by determining, based on a plurality of simulated multiagent adversarial scenes, an optimal hyperparameter combination for the scene manager 110. The scene manager 110 may operate using various hyperparameters defining operational attributes of the scene manager, thresholds, and the like, as well as hyperparameters for any implemented neural networks (e.g., learning rate, discount facture, overall structure, and the like). The scene manager training module 118 may run multiple simulations of multiagent adversarial scenes using various combinations of hyperparameters and evaluate the performance of the simulations using various metrics (e.g., friendly agent 112 victories, adversarial agent victories, elimination rates for friendly or adversarial agents, and the like). The optimal combination of hyperparameters may then be used by the scene manager 110.

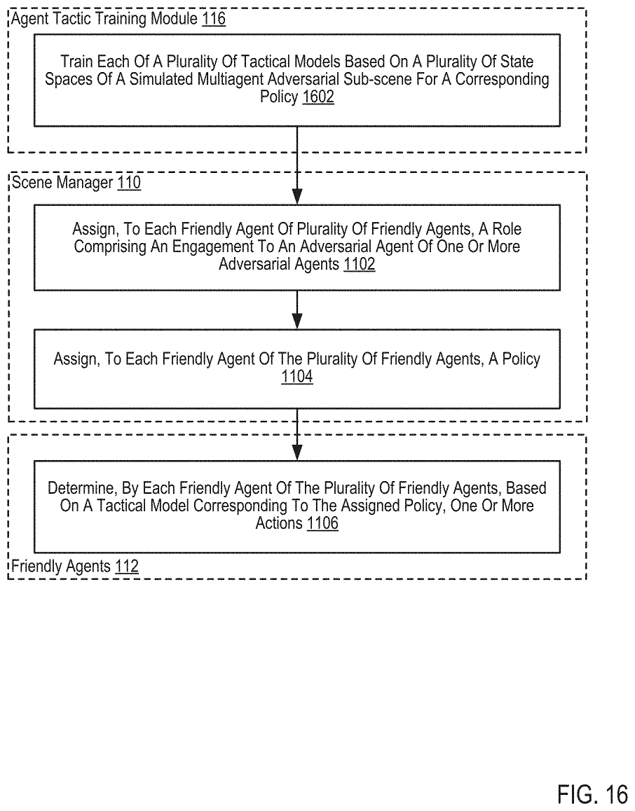

For further explanation, FIG. 16 sets forth a flow chart illustrating an exemplary method for autonomous behaviors in a multiagent adversarial scene that includes assigning 1102 (e.g., by a scene manager 110), to each friendly agent 112 of a plurality of friendly agents 112, a role comprising an engagement to an adversarial agent of one or more adversarial agents; assigning 1104 (e.g., by the scene manager 110), to each friendly agent 112 of the plurality of friendly agents 112, a policy; and determining 1106, by each friendly agent 112 of the plurality of friendly agents 112, based on a tactical model 114 corresponding to the assigned policy, one or more actions.

The method of FIG. 16 differs from FIG. 11 in that the method of FIG. 16 also includes training 1602 (e.g., by the agent tactic training module 116) each of a plurality of tactical models 115 based on a plurality of state spaces of a simulated multiagent adversarial sub-scene for a corresponding policy. For example, each role (e.g., engagement configuration) and policy combination corresponds to a particular tactical model 114. To ensure coverage with respect to the entire state space of a given sub-scene, simulated friendly agent(s) 112 are placed in an environment of a simulated state space relative to a simulated adversarial agent. For example, simulated friendly agent(s) 112 may be randomly placed in a simulated state space centered on a simulated adversarial agent, and a simulation is run. Friendly agent 112 placement and simulations are repeatedly performed until a termination condition is met (e.g., convergence, or a maximum number of steps or iterations are performed). In some embodiments, the simulated friendly agent(s) are placed within a constrained area within the simulated state space (e.g., close to an engaged adversarial agent). The constrained area may be expanded over time in order such that the tactical models 114 are trained. For example, the tactical models 114 are trained to solve easier or less computationally complex problems first. The difficulty or complexity to accomplish the same task is then increased over the learning process.

In view of the explanations set forth above, readers will recognize that the benefits of autonomous behaviors in a multiagent adversarial scene according to embodiments of the present invention include:
A portable architecture for autonomous behaviors in a multiagent adversarial scene that may be ported to different platform by switching an asset management layer.
Improved efficiency and training Each layer can be trained individually and independently of the others, thereby reducing the action space that must be considered for learning a policy for that level. Moreover, tactical models may be trained on the sub-scene level, further reducing the action space and training space.

Exemplary embodiments of the present invention are described largely in the context of a fully functional computer system for autonomous behaviors in a multiagent adversarial scene. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s).

In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood that any of the functionality or approaches set forth herein may be facilitated at least in part by artificial intelligence applications, including machine learning applications, big data analytics applications, deep learning, and other techniques. Applications of such techniques may include: machine and vehicular object detection, identification and avoidance; visual recognition, classification and tagging; algorithmic financial trading strategy performance management; simultaneous localization and mapping; predictive maintenance of high-value machinery; prevention against cyber security threats, expertise automation; image recognition and classification; question answering; robotics; text analytics (extraction, classification) and text generation and translation; and many others.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for autonomous behaviors in a multiagent adversarial scene, comprising:
assigning, by a scene manager, to each friendly agent of a plurality of friendly agents, a role comprising an engagement to an adversarial agent of one or more adversarial agents;
assigning, by the scene manager, to each friendly agent of the plurality of friendly agents, a policy; and
wherein each friendly agent of the plurality of friendly agents is configured to determine actions based on a tactical model corresponding to the assigned policy.

2. The method of claim 1, wherein assigning, to each friendly agent of the plurality of friendly agents, the role comprises:
calculating, based on the plurality of friendly agents and the one or more adversarial agents, a plurality of costs; and
assigning, to each friendly agent of the plurality of friendly agents, the role based on the plurality of costs.

3. The method of claim 2, wherein the plurality of costs is based on one or more other friendly agents and wherein assigning, to each friendly agent of the plurality of friendly agents, the role further comprises assigning the one or more other friendly agents to a non-engagement role.

4. The method of claim 1, wherein the policy is assigned based on a location of each friendly agent relative to a corresponding engaged adversarial agent.

5. The method of claim 1, further comprising determining, by the scene manager, whether to reassign one or more of the friendly agents to a new role in response to an event.

6. The method of claim 5, wherein the event comprises an elimination of an agent.

7. The method of claim 5, wherein the event comprises a friendly agent entering a risk zone.

8. The method of claim 5, wherein the event comprises a new agent entering the multiagent adversarial scene.

9. The method of claim 5, wherein the event comprises a predefined time interval occurring.

10. The method of claim 1, wherein determining actions by each friendly agent of the plurality of friendly agents is further based on, for each friendly agent, observations of a sub-scene comprising an assigned adversarial agent.

11. The method of claim 10, wherein the observations within the sub-scene are independent of agents other than the assigned adversarial agent and any other agents assigned to the assigned adversarial agents.

12. The method of claim 1, further comprising training the scene manager by determining, based on a plurality of simulated multiagent adversarial scenes, a hyperparameter combination for the scene manager.

13. The method of claim 1, wherein the tactical model is included in a plurality of tactical models corresponding to a plurality of policies, and the method further comprises training each of the plurality of tactical models for a simulated multiagent adversarial sub-scene for a corresponding policy.

14. A system for autonomous behaviors in a multiagent adversarial scene, comprising:
a processor;
a memory storing instructions executable by the processor that, when executed, cause the system to perform steps comprising:
assigning, by a scene manager, to each friendly agent of plurality of friendly agents, a role comprising an engagement to an adversarial agent of one or more adversarial agents;
assigning, by the scene manager, to each friendly agent of the plurality of friendly agents, a policy; and
wherein each friendly agent of the plurality of friendly agents is configured to determine actions based on a tactical model corresponding to the assigned policy.

15. The system of claim 14, wherein assigning, to each friendly agent of the plurality of friendly agents, the role comprises:
calculating, based on the plurality of friendly agents and the one or more adversarial agents, a plurality of costs; and
assigning, to each friendly agent of the plurality of friendly agents, the role based on the plurality of costs.

16. The system of claim 14, wherein the plurality of costs is based on one or more other friendly agents and wherein assigning, to each friendly agent of the plurality of friendly agents, the role further comprises assigning the one or more other friendly agents to a non-engagement role.

17. The system of claim 14, wherein the policy is assigned based on a location of each friendly agent relative to a corresponding engaged adversarial agent.

18. The system of claim 14, wherein the steps further comprise determining, by the scene manager, whether to reassign one or more of the friendly agents to a new role in response to an event.

19. The system of claim 18, wherein the event comprises an elimination of an agent.

20. The system of claim 18, wherein the event comprises a friendly agent entering a risk zone.

21. The system of claim 18, wherein the event comprises a new agent entering the multiagent adversarial scene.

22. The system of claim 18, wherein the event comprises a predefined time interval occurring.

23. The system of claim 14, wherein determining actions by each friendly agent of the plurality of friendly agents is further based on, for each friendly agent, observations of sub-scene comprising an assigned adversarial agent.

24. The system of claim 23, wherein the observations within the sub-scene are independent of agents other than the assigned adversarial agent and any other agents assigned to the assigned adversarial agents.

25. The system of claim 14, wherein the steps further comprise training the scene manager by determining, based on a plurality of simulated multiagent adversarial scenes, a hyperparameter combination for the scene manager.

26. The system of claim 14, wherein the tactical model is included in a plurality of tactical models corresponding to a plurality of policies, and the steps further comprise training each of the plurality of tactical models for a simulated multiagent adversarial sub-scene for a corresponding policy.
